(19) United States
(12) Patent Application Publication
(10) Pub. No.: US 2013/0141614 A1
(43) Pub. Date: Jun. 6, 2013

(54) SHADING CORRECTION METHOD FOR IMAGE CAPTURING APPARATUS, AND IMAGE CAPTURING APPARATUS

(71) Applicant: CANON KABUSHIKI KAISHA, Tokyo (JP)

(72) Inventor: Kazuaki Tashiro, Ebina-shi (JP)

(73) Assignee: CANON KABUSHIKI KAISHA, Tokyo (JP)

(21) Appl. No.: 13/665,358

(22) Filed: Oct. 31, 2012

(30) Foreign Application Priority Data
Dec. 5, 2011 (JP) 2011-266273

(51) Int. Cl. H04N 9/68

(52) U.S. Cl. 348/238; 348/E09.053

(57) ABSTRACT

An image shading correction method for an image capturing apparatus, comprising an obtaining step of obtaining a first image signal of an image captured of an area having a uniform luminance distribution using another image capturing apparatus that is different from the image capturing apparatus under a first condition, a second image signal of an image captured of the area having a uniform luminance distribution using the other image capturing apparatus under a second condition, and a third image signal of an image captured of the area having a uniform luminance distribution using the image capturing apparatus under the first condition, and a correction step of performing, based on the first to third image signals, correction processing on an image of an object captured using the image capturing apparatus under the second condition.

### BACKGROUND OF THE INVENTION

1. Field of the Invention

The present invention relates to shading correction methods for image capturing apparatuses, and image capturing apparatuses.

2. Description of the Related Art

Image capturing apparatuses are capable of internally correcting shading of captured images. According to Japanese Patent Laid-Open No. 2008-177794, information concerning shading unique to each image capturing apparatus is obtained in advance for each color, and the image capturing apparatus corrects shading in accordance with this unique information when capturing images.

Image capturing apparatuses can be used under various differing conditions of optical systems, operation environments, operation modes, or the like. Here, according to Japanese Patent Laid-Open No. 2008-177794, it is necessary to obtain all information concerning shading unique to the respective image capturing apparatuses for each of different conditions. Considering provision of image capturing apparatuses capable of handling various conditions, the amount of information to be obtained and necessary man-hours could be huge.

Moreover, even if a pixel area is designed under the same conditions, the pixel aperture size, the thickness of color filters, or the like varies due to manufacturing variation occurring during etching, processing, or the like at the time of manufacturing. As a result, it becomes difficult to make light-receiving characteristics uniform over the entire pixel area, and local color heterogeneity or color shading over a broad area may be caused. Furthermore, variation occurs not only within a pixel area but also among image sensors, and therefore, color heterogeneity and color shading unique to image sensors can vary and differ among image sensors. After these image sensors are incorporated into cameras, color heterogeneity and color shading under each condition of each optical system (such as lens type, f-number, eye relief, zoom position, and type of IR cut filter) are further added. As a result, the final color heterogeneity and color shading can be different among image capturing apparatuses. Furthermore, even in a single image capturing apparatus, color heterogeneity and color shading characteristics can differ depending on shooting conditions.

### SUMMARY OF THE INVENTION

The present invention provides a technique advantageous for shading correction under various conditions.

One of the aspects of the present invention provides an image shading correction method for an image capturing apparatus, comprising, an obtaining step of obtaining a first image signal of an image captured of an area having a uniform luminance distribution using another image capturing apparatus that is different from the image capturing apparatus under a first condition, a second image signal of an image captured of the area having a uniform luminance distribution using the other image capturing apparatus under a second condition that is different from the first condition, and a third image signal of an image captured of the area having a uniform luminance distribution using the image capturing apparatus under the first condition, and a correction step of performing, based on the first to third image signals obtained in the obtaining step, correction processing on an image of an object captured using the image capturing apparatus under the second condition.

Further features of the present invention will become apparent from the following description of exemplary embodiments with reference to the attached drawings.

### BRIEF DESCRIPTION OF THE DRAWINGS

FIG. 1 is a chart illustrating correspondence between symbols of image signals obtained when capturing images of an area having a uniform luminance distribution;

FIGS. 2A and 2B are diagrams showing vector components in RB color space of measurement images captured using an image capturing apparatus 1 under conditions L1 and Lj, respectively;

FIGS. 3A and 3B are diagrams showing vector components in RB color space of measurement images captured using an image capturing apparatus i under conditions L1 and Lj, respectively;

FIG. 4 is a diagram for illustrating difference vector components between the measurement images captured using the image capturing apparatus 1 under the conditions L1 and Lj;

FIG. 5 is a diagram showing a result of calculating vector components in the case of capturing an image using the image capturing apparatus i under the condition Lj;

FIG. 6 is a graph for illustrating exemplary shading properties of the image capturing apparatus i under the condition Lj;

FIG. 7 is a graph showing normalized exemplary shading properties of the image capturing apparatus i under the condition Lj;

FIG. 8 is a graph showing color ratios of the normalized shading properties;

FIG. 9 is a graph showing color-ratio (R/G) shading properties of the image capturing apparatus 1 under the conditions L1 and Lj;

FIG. 10 is a graph showing difference information between the color-ratio (R/G) shading properties of the image capturing apparatus 1 under the conditions L1 and Lj;

FIG. 11 is a graph showing a result of calculating the color-ratio shading properties of the image capturing apparatus i under the condition Lj;

FIG. 12 is a graph showing a shading correction function for the image capturing apparatus i under the condition Lj;

FIGS. 13A and 13B are flowcharts for obtaining shading properties; and

FIG. 14 is a diagram for illustrating an exemplary image capturing system.

### DESCRIPTION OF THE EMBODIMENTS

### First Embodiment

In the first embodiment, the case of correcting shading of images captured using image capturing apparatuses arbitrarily selected from among a plurality of image capturing apparatuses 1 to m, under conditions arbitrarily selected from among a plurality of conditions L1 to Ln will be considered. The conditions L1 to Ln can include, for example, settings of the optical system, and correspond to conditions at the time of shooting using the image capturing apparatuses 1 to m, respectively. Specifically, for example, the conditions can include the lens type, f-number, eye relief, lens position, and IR cut filter type, as well as light source type of the image capturing apparatuses 1 to m.

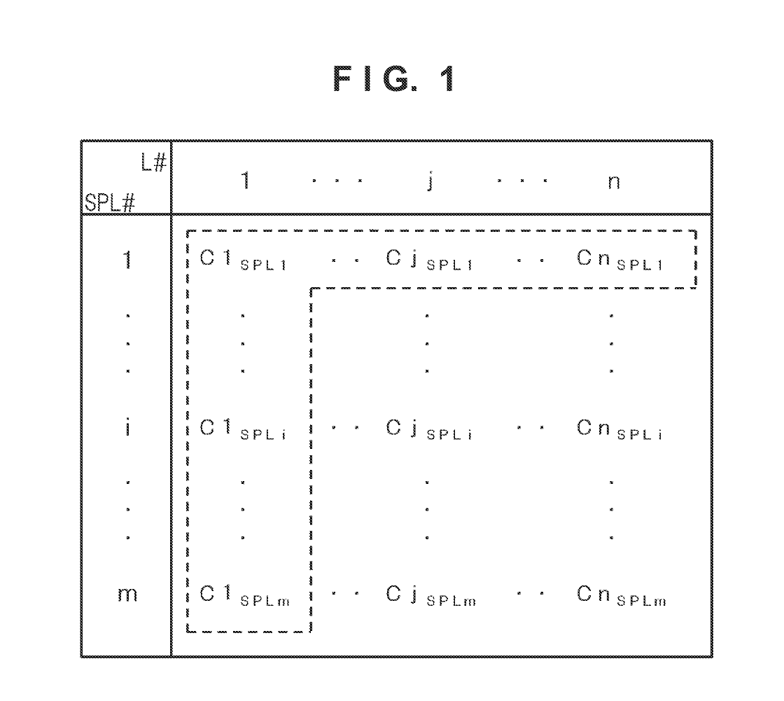

Hereinafter the shading correction method according to the present embodiment will be described with reference to FIGS. 1 to 5. The shading correction method according to the present embodiment can include an obtaining step and a correction step. The obtaining step is a step of obtaining in advance, for example, at least three image signals prior to the correction step, which will be described later. FIG. 1 is a table showing signals of images captured using the image capturing apparatuses 1 to m under the conditions L1 to Ln. The row direction indicates the image capturing apparatuses 1 to m (SPL #), and the column direction indicates the conditions L1 to Ln (L#). First, from among the image capturing apparatuses 1 to m, an image capturing apparatus that can serve as a standard for comparison (e.g., the image capturing apparatus 1) and an image capturing apparatus to be subjected to shading correction (e.g., the image capturing apparatus i) can be selected. Although the image capturing apparatus 1 is selected here as the image capturing apparatus that can serve as the standard for comparison, it can be arbitrarily selected from among the image capturing apparatuses 1 to m. The image capturing apparatus i to be subjected to shading correction can be selected from among the remaining image capturing apparatuses 2 to m. From among the conditions L1 to Ln, the first condition that can serve as a standard for comparison and the second condition under which an image to be subjected to shading correction is captured can be selected. As the first condition, for example, a condition L1 can be selected in the present embodiment. The first condition is not limited to a specific condition, but need only be able to serve as a standard for obtaining a prescribed image signal, and may be, for example, an optimum and normal condition in an inspecting step in the image capturing apparatuses 1 to m. As the second condition, for example, a condition Lj can be selected from the remaining conditions L2 to Ln.

In the obtaining step, at least three image signals, for example, can be obtained using the image capturing apparatuses 1 and i under the conditions L1 and Lj. As the first image signal, an image signal C1_{SPL1} at the time of capturing an image of an area having a uniform luminance distribution using the image capturing apparatus 1 under the first condition (here, the condition L1) can be obtained. As the second image signal, an image signal Cj_{SPL1} at the time of capturing an image of the area having a uniform luminance distribution using the image capturing apparatus 1 under the second condition (here, the condition Lj) can be obtained. As the third image signal, an image signal C1_{SPLi} at the time of capturing an image of the area having a uniform luminance distribution using the image capturing apparatus i under the first condition (here, the condition L1) can be obtained.

Next, the correction step will be described. The correction step is a step in which correction processing can be performed on an image of an object captured using the image capturing apparatus i under the condition Lj based on the first to third image signals (C1_{SPL1}, Cj_{SPL1}, and C1_{SPLi}) obtained in the above-described obtaining step. In other words, image shading correction can be performed without obtaining in advance shading properties of the image capturing apparatus i under the condition Lj.

This correction step can include, for example, a calculating step and an arithmetic step. The calculation step is a step of calculating, based on the image signals C1_{SPL1}, Cj_{SPL1}, and C1_{SPLi} obtained in the above-described obtaining step, the fourth image signal Cj_{SPLi} that can be obtained when capturing an image of the area having a uniform luminance distribution using the image capturing apparatus i under the condition Lj. The image signals C1_{SPL1}, Cj_{SPL1}, and C1_{SPLi} are respectively shading properties that can be obtained by capturing images of the area having a uniform luminance distribution. In the calculation step, the shading properties at the time of using the image capturing apparatus i under the condition Lj can be computed using the obtained shading properties. The arithmetic step is a step of performing shading correction on an image of an object captured using the image capturing apparatus i under the condition Lj by arithmetic processing using the shading properties obtained in the calculation step. One specific method including the above-mentioned steps will be described below as an example.

First, the calculation step will be described. For example, a difference signal ΔDj_{SPL1} is obtained with respect to the image signals C1_{SPL1} and Cj_{SPL1} at the time of capturing the images of an area having a uniform luminance distribution using the image capturing apparatus 1 under the conditions L1 and Lj (the first step). Accordingly,

Cj_{SPL1}=C1_{SPL1}+ΔDj_{SPL1} Equation (1)

Similarly, the following equation (2) can be obtained with respect to the image signals C1_{SPLi} and Cj_{SPLi} at the time of capturing the images using the image capturing apparatus i under the conditions L1 and Lj:

Cj_{SPLi}=C1_{SPLi}+ΔDj_{SPLi} Equation (2)

The image capturing apparatuses 1 to m (including the image capturing apparatus i) conform to the same design condition, but may have different shading properties as mentioned in the Background of the Invention. Meanwhile, the inventor found from the result of experiment that the elements constituting the difference signal ΔDj_{SPLi} between the conditions L1 and Lj in the arbitrary image capturing apparatus i can be approximately constant. In other words, the following formula holds for arbitrary j (j=1 to n):

ΔDj_{SPL1}≈ . . . ≈ΔDj_{SPLi}≈ . . . ≈ΔDj_{SPLn} Equation (3)

Here, from the equations (2) and (3),

Cj_{SPLi}≈C1_{SPLi}+ΔDj_{SPL1}=Cj_{SPLi}′ Equation (4)

Cj_{SPLi}′ is an image signal that can be obtained when capturing an image of the area having a uniform luminance distribution using the image capturing apparatus i under the condition Lj. Thus, the image signal Cj_{SPLi}′ can be computed by adding the difference signal ΔDj_{SPL1} to the image signal C1_{SPLi}, and the shading properties of the image capturing apparatus i under the condition Lj can be computed (the second step).

The image signals are represented with a symbol C in the above description, but if, for example, the image signals have composite colors (in the case of a color image), image signals can be considered individually for red (R), green (G), and blue (B) color elements in accordance with Grassmann's law. For example, arbitrary light C can be represented by a sum of vector components in color space of light (three-dimensional coordinates consisting of R, G, and B), and expressed as C=α×R+β×G+γ×B. Here, α, β, and γ are arbitrary constants. Further, in the above description, the vector components (C1_{SPL1}, Cj_{SPLi}, etc.) can be defined for each of a plurality of pixels provided to the respective image capturing apparatuses 1 to m. Assuming an arbitrary pixel position in a pixel area is (x, y), C1_{SPL1} can be represented as C1_{SPL1}(x, y). Here, for the sake of simple explanation, a single pixel in the pixel area is focused on, and the vector component thereof is expressed simply as C1_{SPL1}. The same applies to other symbols. The same further applies to the following description.

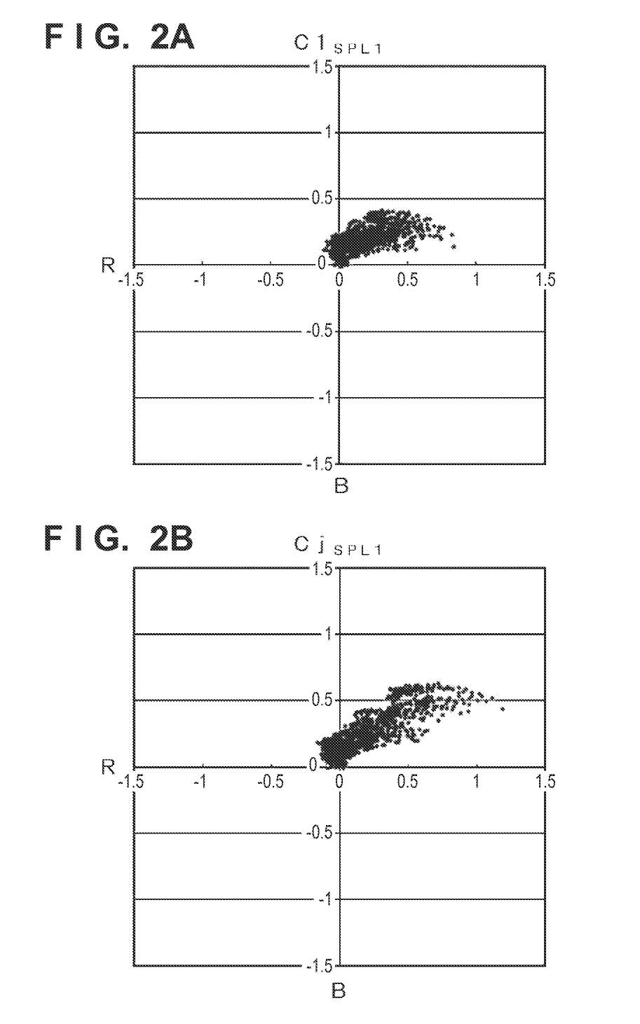

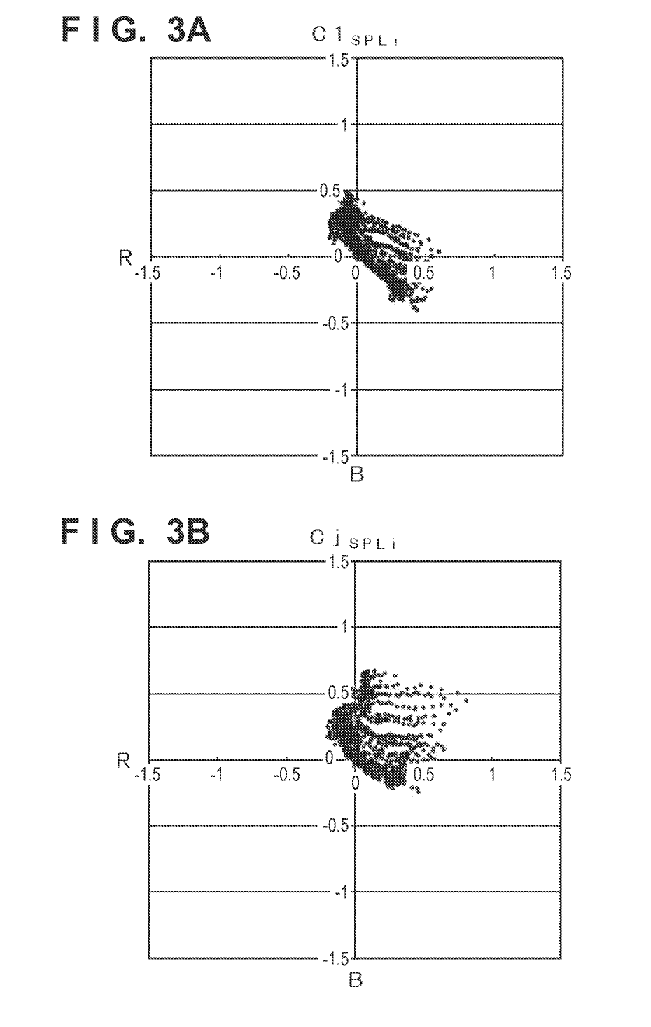

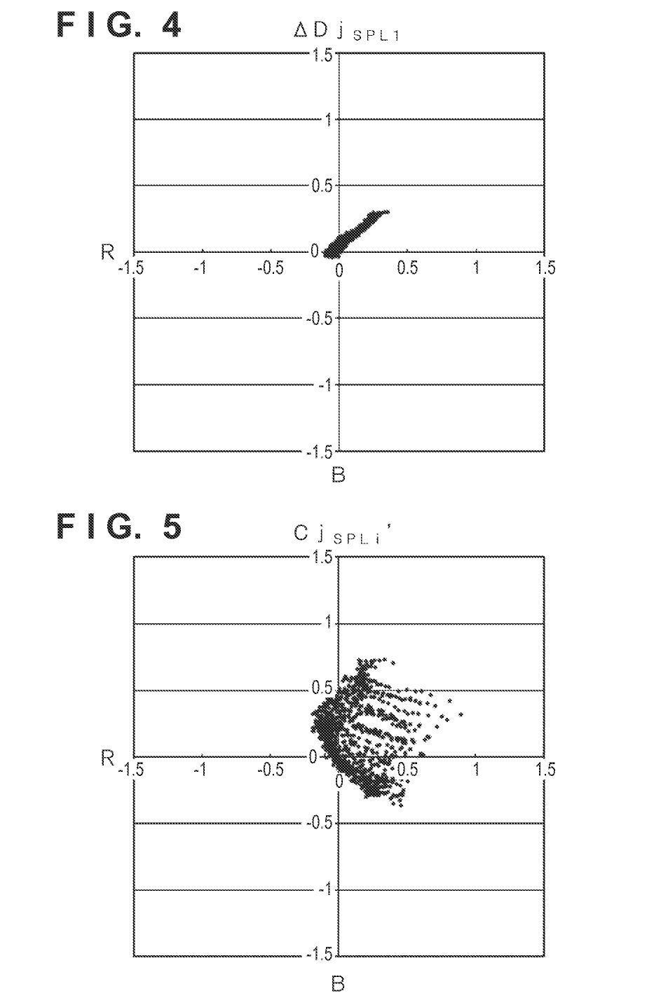

The equation (4) will now be considered using measurement results. Here, the condition L1 was an eye relief of the lens of 80 mm, the condition Lj was an eye relief of the lens of 56 mm, and a light source for illuminating a target object with light having uniform luminance was prepared. FIG. 2A is a graph showing, for example, the measurement result concerning C1_{SPL1}, represented by two-dimensional vector coordinates, with the horizontal axis indicating a light vector component (B) of a blue color element, and the vertical axis indicating a light vector component (R) of a red color element. Each plot shown in FIG. 2A corresponds to the vector component of each pixel in the pixel area. In other words, the plots being dispersed indicate that there is shading in the image capturing apparatus 1. Similarly, FIG. 2B is about Cj_{SPL1}, FIG. 3A is about C1_{SPLi}, and FIG. 3B is about Cj_{SPL1}. For example, as is understood from comparison between C1_{SPL1} and C1_{SPLi}, the image capturing apparatuses 1 and i obtain different image signals under the same condition L1, and therefore have different shading properties. FIG. 4 is a diagram showing difference signals ΔDj_{SPL1} (difference vector components). Here, if the image signal Cj_{SPLi}′ computed in accordance with the equation (4) is obtained, the vector components thereof are as shown in FIG. 5, and can substantially agree with those of the image signal Cj_{SPLi} shown as the measurement result in FIG. 3B. This fact indicates that the shading properties in the image capturing apparatus i under the condition Lj can be predicted with high accuracy based on C1_{SPL1}, Cj_{SPL1}, and C1_{SPLi}.

In the arithmetic step after the calculation step, shading correction can be performed on the image of an object captured using the image capturing apparatus i under the condition Lj based on the shading properties computed in the calculation step. For example, firstly, a function for correcting image shading (hereinafter referred to simply as “correction function”) can be generated based on the shading properties computed in the calculation step (third step). Here, for example, an inverse function of the computed shading properties may be obtained as the correction function for each color. This correction function, if considered based on, for example, the vector components in the color space as mentioned above, can also be generated as an inverse function derived from ratios of scalar quantities thereof to prescribed values. These prescribed values may be, for example, values normalized by output values in arbitrary coordinates in the pixel area. Thereafter shading can be corrected by multiplying the image of the object captured using the image capturing apparatus i under the condition Lj by this correction function (fourth step).

In the above description, the case of changing the settings of the optical system, which serve as the conditions L1 to Ln, was described as an example. The conditions L1 to Ln can also include the operating environment (e.g., temperature and humidity), operating mode (e.g., shooting modes such as landscape mode, night scene mode, and portrait mode), and so on. Conventionally, the unique information (Cj_{SPLi} in the present embodiment) concerning shading in the image capturing apparatus i with respect to the condition Lj (any one of the conditions L1 to Ln) at the time of shooting has needed to be obtained in advance by capturing images. With the present invention, information (Cj_{SPLi}′) necessary for shading correction can be generated using basic information (C1_{SPL1}) unique to another image capturing apparatus 1, information (Cj_{SPL1}) on the image capturing apparatus 1 at the time of shooting, and basic information (C1_{SPLi}) unique to an image capturing apparatus i. In the present embodiment, the difference ΔDj_{SPL1} from the basic information at the time of shooting was computed as auxiliary information from C1_{SPL1} and Cj_{SPL1}, the computed difference was added to C1_{SPLi}, and thus Cj_{SPLi}′ was generated. In other words, according to the present invention, shading correction can be performed without directly obtaining the unique information (Cj_{SPLi}) concerning the shading in the image capturing apparatus i. Accordingly, shading correction can be advantageously performed under various conditions.

### Second Embodiment

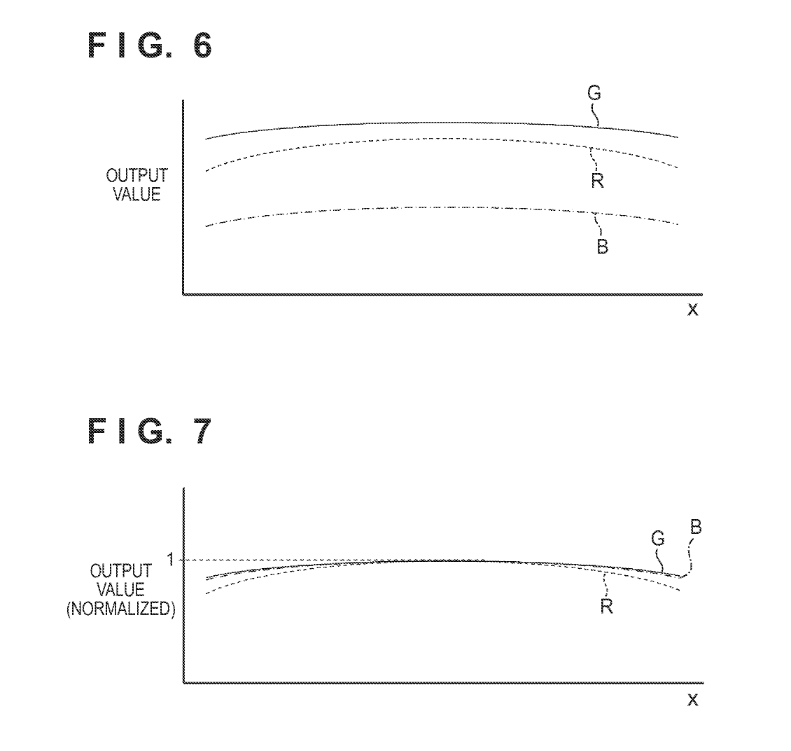

The shading correction method according to the second embodiment will be described with reference to FIGS. 6 to 12. As described below, image shading can also be corrected using ratios between color elements (hereinafter referred to simply as “color ratio”). First, in the obtaining step, for example, at least three image signals C1_{SPL1}, Cj_{SPL1}, and C1_{SPLi} can be obtained using the image capturing apparatuses 1 and i under the conditions L1 and Lj, similarly to the first embodiment. In the present embodiment, the condition L1 is that the f-number of a lens with a focal length of 50 mm and a minimum f-number of 1.4 is set to 5.6. The condition Lj is that the f-number of a lens with a focal length of 50 mm and a minimum f-number of 1.4 is set to 2.8.

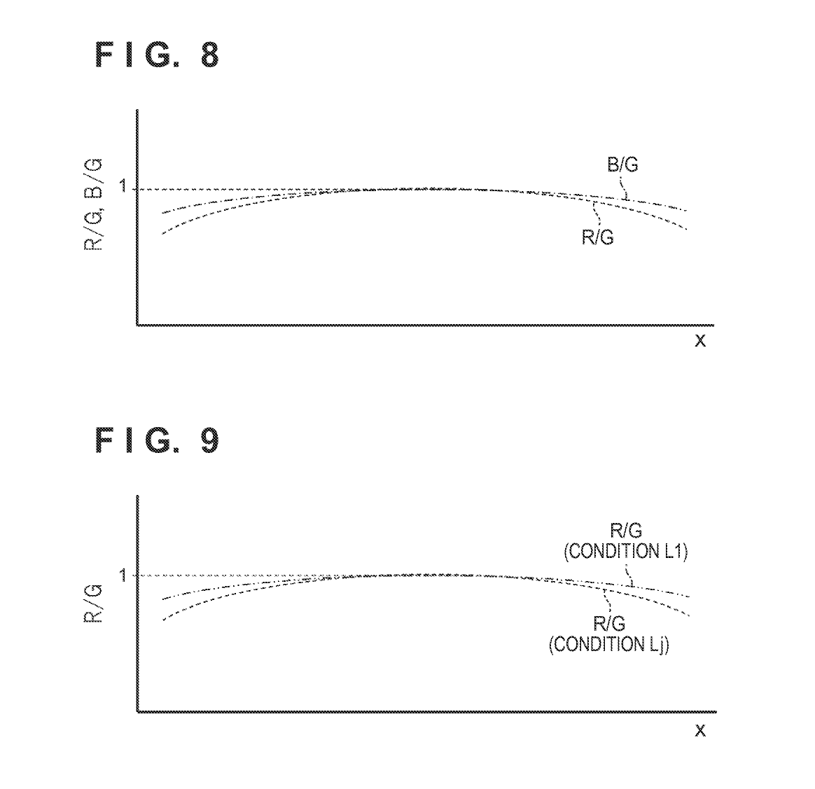

The case where the image capturing apparatus 1 is used under the condition Lj will be described, but the same applies to the condition L1. First, FIG. 6 shows shading properties of each color element of the image signal Cj_{SPL1}. The horizontal axis indicates the position x in the horizontal direction of pixel area coordinates (x, y). The vertical axis indicates the output value of each of the color elements (R, G, and B) at the pixel corresponding to the coordinate x. The horizontal axis here indicates the position x in the horizontal direction of the pixel area, while the position y in the vertical direction may be similarly considered. The shading properties tend to form a convex shape relative to the center of the pixel area, as shown as the example in FIG. 6, but also form a concave shape in some cases. Next, for example, shading properties resulting from normalizing output values of the respective color elements can be obtained. In the present embodiment, as shown as an example in FIG. 7, the output values were normalized using the output values of the central pixel in the pixel area as a reference. After that, as shown as an example in FIG. 8, color-ratio shading properties R/Gj_{SPL1} and B/Gj_{SPL1} of the image signal can be obtained.

Also of the image signal C1_{SPL1}, the color-ratio shading properties R/G1_{SPL1} and B/G1_{SPL1} can be similarly obtained. FIG. 9 shows the color-ratio shading properties R/G1_{SPL1} and R/Gj_{SPL1} under the conditions L1 and Lj, respectively. The same description applies to B/G1_{SPL1} and B/Gj_{SPL1}, which are not shown in the figure. The color-ratio shading properties R/G1_{SPLi} and B/G1_{SPLi} can also be similarly obtained for the image signal C1_{SPLi}. Thus, the correction step including the calculation step and arithmetic step may be performed after the color-ratio shading properties are obtained after the obtaining step in the first embodiment.

In the calculation step, difference information between the color-ratio shading properties under the conditions L1 and Lj can be computed. In other words, as shown as an example in FIG. 10, the difference information ΔD_{R/G}j_{SPL1}=R/Gj_{SPL1}−R/G1_{SPL1} can be obtained. The same description applies to ΔD_{B/G}j_{SPL1}, which is not shown in the figure.

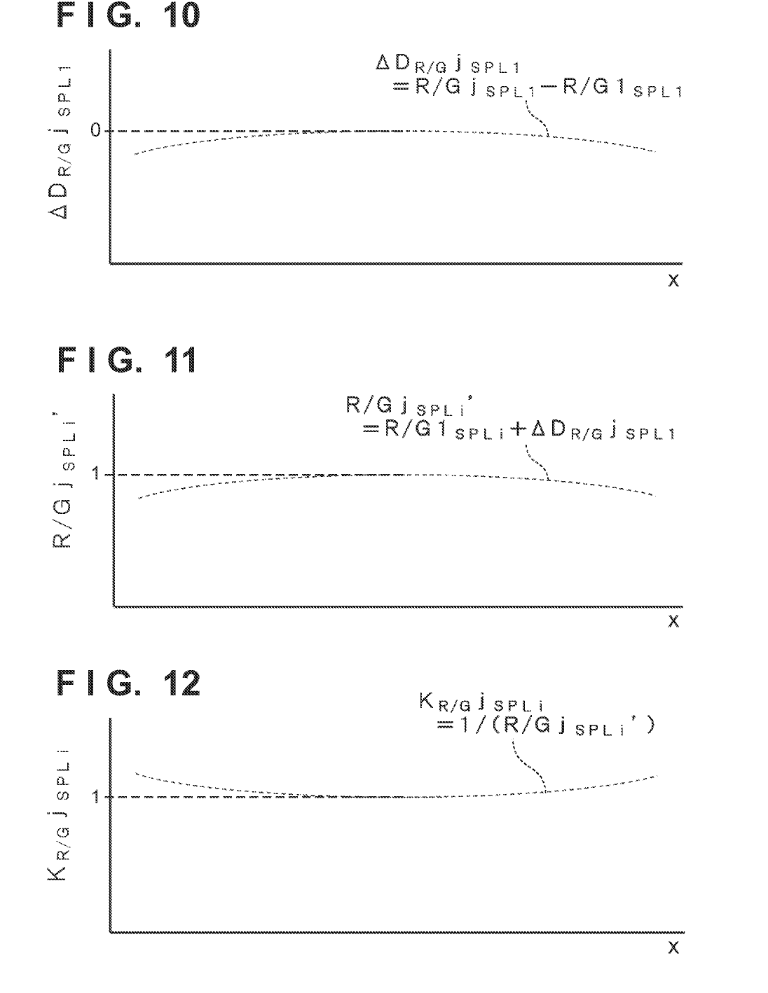

In the arithmetic step, shading correction cab be performed on the image of an object captured using the image capturing apparatus i under the condition Lj based on the computation result in the calculation step. Here, for example an inverse function of the computed color-ratio shading properties may be obtained as a correction function. In other words, as shown as an example in FIG. 11, the color-ratio shading properties R/Gj_{SPLi}′ and B/Gj_{SPLi}′ at the time of using the image capturing apparatus i under the condition Lj can be computed in accordance with the equation (4). Accordingly, as shown as an example in FIG. 12, (1/(R/Gj_{SPLi}′)) may be used as the correction function K_{R/G}j_{SPLi}. Similarly, (1/(B/Gj_{SPLi}′)) may be used as the correction function K_{B/G}j_{SPLi}.

After that, shading can be corrected by multiplying the image of the object captured using the image capturing apparatus i under the condition Lj by these correction functions. For example, the image of the object of the respective color elements (R, G, and B) captured using the image capturing apparatus i under the condition Lj are assumed as Xj_{SPLi}, Yj_{SPLi}, and Zj_{SPLi}, respectively. Those image signals of the object can be normalized through the same process, and the image information X/Yj_{SPLi} and Z/Yj_{SPLi} based on the color ratios can be obtained. At this time, shading correction is performed on X/Yj_{SPLi} by multiplying (X/Yj_{SPLi}) by K_{R/G}j_{SPLi}. Similarly, for Z/Yj_{SPLi}, multiplication: (Z/Yj_{SPLi})×K_{B/G}j_{SPLi} can be performed. Thus, shading correction can be advantageously performed under various conditions.

Regarding the symbols used in the above description, if an arbitrary pixel position in the pixel area is assumed as (x, y), R/Gj_{SPL1} can be expressed as R/Gj_{SPL1}(x, y), for example. Here, for the sake of simple explanation, a single pixel in the pixel area is focused on, and the color-ratio properties are expressed simply as R/Gj_{SPL1}. The same applies to other symbols. Generally, color shading can vary slowly relative to the pixel pitch. Accordingly, the pixel area may be partitioned into several blocks, and the above-described shading correction may be performed by block. In this case, the volume of information that is obtained in advance in the obtaining step and the man-hours in the calculation step and arithmetic step can be reduced. Also in the case where symmetrical (e.g., concentric) shading properties are anticipated, the above-described processing is similarly performed in the horizontal or vertical direction, and thus man-hours can be reduced. In the present embodiment, the case of correcting image shading using the color ratios has been described, but the shading correction may alternatively be performed using the output values normalized for the respective color elements (R, G, and B).

### Third Embodiment

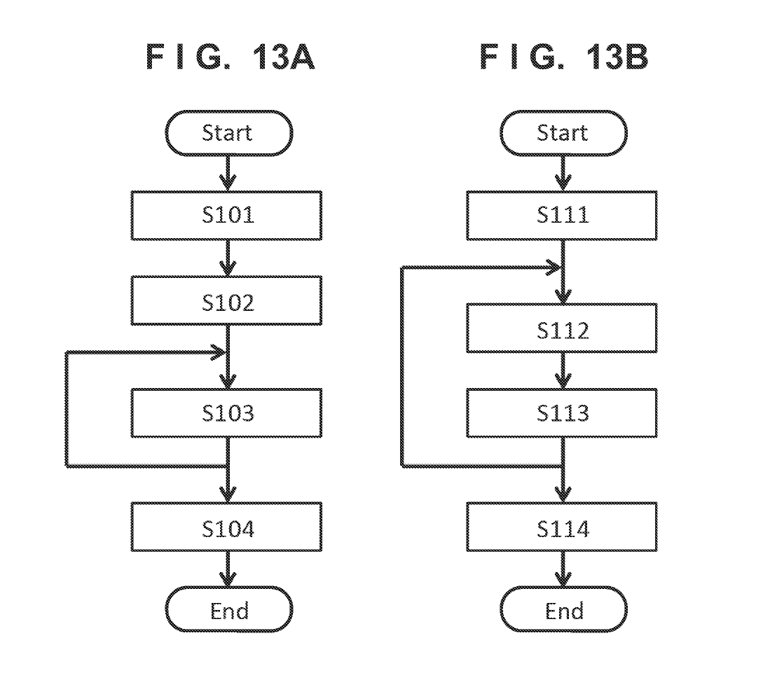

The present invention is effective also in the case of, for example, comprehensively inspecting shading in the image capturing apparatuses 1 to m under the conditions L1 to Ln. The specific content of the inspecting step will be described with reference to FIGS. 1 and 13 for the case of, for example, performing image shading correction using color ratios, as in the second embodiment.

In the obtaining step, image signals C1_{SPL1} and C1_{SPLm} at the time of capturing an image of an area having a uniform luminance distribution using the image capturing apparatuses 1 to m under the condition L1 can be obtained. This can be performed in accordance with the procedure shown as an example in FIG. 13A. In step S101, a light source having a uniform luminance is prepared. In step S102, the shooting condition is set in advance to the condition L1. In step S103, with the image capturing apparatus i (here, i is any one of 1 to m) the image signals C1_{SPLi} at the time of capturing an image of an area having a uniform luminance distribution under the condition L1 can be sequentially obtained. In step S104, for example, the color-ratio shading properties can be obtained here using the results obtained in step S103. Thus C1_{SPL1} to C1_{SPLm} can be obtained, namely, the standard information uniquely held by the image capturing apparatuses 1 to m can be obtained.

Also in the obtaining step, image signals C2_{SPL1} and C2_{SPL1} at the time of capturing an image of an area having a uniform luminance distribution using the image capturing apparatuses 1 to m under the conditions L2 to Ln can be obtained. This can be performed in accordance with the procedure shown as an example in FIG. 13B. In step S111, a light source having a uniform luminance is prepared. In step S112, the shooting condition can be set to the condition Lj (here, j is any one of 2 to n). In step S113, with the image capturing apparatus 1, the image signal Cj_{SPL1} at the time of capturing an image of an area having a uniform luminance distribution under the condition Lj can be obtained. In steps S112 and S113, the image signals C2_{SPL1} to Cn_{SPL1} under the conditions L2 to Ln are sequentially obtained. In step S114, for example, various color-ratio shading properties can be obtained here using the results obtained in step S113. Thus C2_{SPL1} to Cn_{SPL1} can be obtained, and for example, auxiliary information indicating the difference information between the conditions L1 and Lj can be obtained.

Either of those two obtaining steps (S101 to S104 and S111 to S114) may be performed at first. In other words, in the obtaining step, the image signals surrounded by the dotted line in FIG. 1 can be obtained in advance. Other image signals can be computed in the calculation step, as described above. With the conventional methods, the image capturing apparatuses 1 to m are inspected for each of the conditions L1 to Ln, and measurement needs to be performed m×n times. On the other hand, according to the present embodiment, each of the image capturing apparatuses 1 to m is inspected under the condition L1, and the image capturing apparatus 1 is inspected for each of the conditions L2 to Ln. Therefore, measurement need only be performed m+n−1 times. Accordingly, man-hours for inspection are greatly reduced, and shading correction can be advantageously performed even in inspection performed under various conditions.

Three embodiments have been described above, but the present invention is not limited thereto, and needless to say, the purpose, state, use, function, and any other specifications thereof can be appropriately changed, and implemented in other embodiments. For example, in the case of digital SLR cameras, the conditions L1 to Ln can include the types and positions of interchangeable lenses, but some of those cameras are not provided with an interchangeable lens. In that case, the image signals C1_{SPLi} and so on and the difference signal ΔDj_{SPL1} can include information on whether or not the camera is provided with an interchangeable lens. Further, for example, if the conditions L1 to Ln include the light source type, a sensor capable of detecting the light source type may be provided to each image capturing apparatus, and shading correction suitable for each light source type may be performed.

The shading correction is performed, for example, within each of the image capturing apparatuses 1 to m, and each of the image capturing apparatuses 1 to m can include a shading correction unit for performing shading correction on captured images. Furthermore, each of the image capturing apparatuses 1 to m can include an information holding unit and an arithmetic unit. The information holding unit may hold information associated with the image signals C1_{SPL1}, Cj_{SPL1}, and C1_{SPLi}. This associated information may be the image signals C1_{SPL1}, Cj_{SPL1}, and C1_{SPLi} as they are, or may be information that has been subjected to prescribed signal processing and need only be information that can be used in the subsequent arithmetic processing. The arithmetic unit can performs the arithmetic processing using the information held by the information holding unit. The shading correction unit can perform shading correction on the image of an object captured under the condition Lj, using the result of the arithmetic processing by the arithmetic unit. The information holding unit may further include first and second information holding units. For example, in the case of calculating shading properties in the calculation step as in the first embodiment, the first information holding unit can hold the image signals C1_{SPL1} and Cj_{SPL1} and the difference signal ΔDj_{SPL1}, and the second information holding unit can hold the image signal C1_{SPLi}. In this case, information indicating that the difference signal ΔDj_{SPL1} is a difference signal between the conditions L1 and Lj is also held.

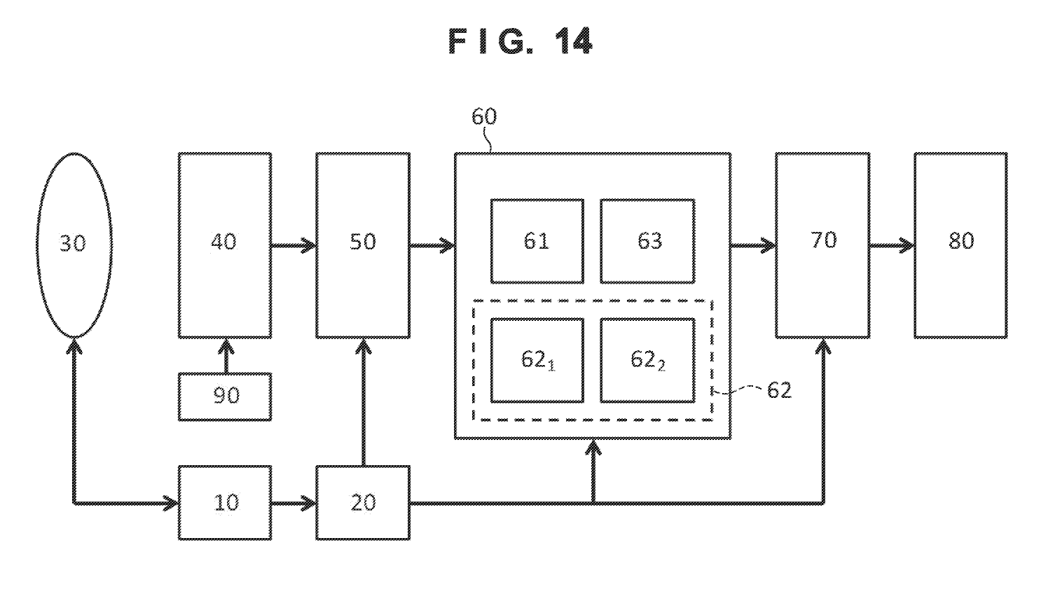

A specific exemplary configuration will be described with reference to FIG. 14. FIG. 14 is a system block diagram of a digital SLR camera that is equipped with the correction method according to the present invention. A lens interface (lens I/F) 10 can obtain setting information on an optical system 30 in response to an instruction from a control unit 20. The setting information on the optical system 30 can include, for example, information about the lens type, eye relief, f-number and lens position, and can be information for selecting one of the conditions L1 to Ln. As an image sensor 40, for example, a CCD or CMOS image sensor can be used. The image sensor 40 can capture an image of an object through the optical system 30, and output an analog image signal to an AFE (Analog Front End) 50. The AFE 50 can perform signal processing, such as signal amplification, on this analog image signal. After that, the AFE 50 can convert, into a digital image signal, the analog image signal that has been subjected to signal processing by, for example, an A/D conversion unit 51 provided to the AFE 50. The digital image signal is output to a DFE (Digital Front End) 60. The DFE 60 can also include, for example, a correction unit 61, and perform offset correction, gain correction, defect correction, and shading correction on the digital image signal. A shading correction unit (not shown in the figure) for performing shading correction on captured images may be included in the correction unit 61. An image processing unit 70 can perform image processing on the digital image signal that has been subjected to the above-mentioned correction. The image processing can include, for example, edge enhancement, color processing, and format conversion for image signals. The image processing unit 70 can also output a signal for displaying the captured image on an image display unit 80 such as a liquid crystal panel. A driving unit 90 can drive the image sensor 40, the AFE 50, the DFE 60, and the image processing unit 70.

The information associated with the shading correction can include, for example, auxiliary information such as the difference signal ΔDj_{SPL1} that is used in the calculation step, and information unique to each image capturing apparatus, such as the image signal C1_{SPLi}, as described above. Such information can be obtained in advance in a manufacturing step (e.g., prior to the inspection) of the image capturing apparatuses 1 to m. After that, the above information may be stored in an information holding unit 62 (here, the first and second information holding units 62₁ and 62₂) in, for example, an assembly step of the image capturing apparatus i. The information may be stored in the information holding unit 62 after the above-mentioned functional blocks are incorporated into the image capturing apparatus i, or before inspection of the image capturing apparatus i. Further, although in FIG. 14 the arithmetic unit 63, the first information holding unit 62₁, and the second information holding unit 62₂ are provided inside the DFE 60, those components may be provided independently, and the configuration thereof can be appropriately changed. Further, the information associated with shading correction can be stored for all pixels in the pixel area. In this case, the correction function can be obtained for all pixels in accordance with the shooting condition. Meanwhile, for example, in the case where an image of a part of the pixel area is displayed, as in live view, only the information associated with shading correction corresponding to that part need be stored.

For example, when a photographer changes the interchangeable lens and sets a new condition Lj′, the information on the optical system, such as the lens type, eye relief, f-number, lens position, and the like can be detected by the control unit 20. In accordance with the above information, the control unit 20 can selects, for example, the information associated with shading correction corresponding to the new condition from the information holding unit 62. The arithmetic unit 63 can perform arithmetic processing using the selected information. After that, the shading correction unit can perform shading correction on an image of an object using the result of the arithmetic processing. As described above, according to the present invention, the image capturing apparatuses 1 to m can collect, within each apparatus, the information associated with shading correction suitable for the shooting condition, and appropriately perform shading correction. It is thus possible to provide image capturing apparatuses that perform shading correction suitable for various conditions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-266273, filed Dec. 5, 2011, which is hereby incorporated by reference herein in its entirety.

What is claimed is:

1. An image shading correction method for an image capturing apparatus, comprising:
an obtaining step of obtaining a first image signal of an image captured of an area having a uniform luminance distribution using another image capturing apparatus that is different from the image capturing apparatus under a first condition, a second image signal of an image captured of the area having a uniform luminance distribution using the other image capturing apparatus under a second condition that is different from the first condition, and a third image signal of an image captured of the area having a uniform luminance distribution using the image capturing apparatus under the first condition; and
a correction step of performing, based on the first to third image signals obtained in the obtaining step, correction processing on an image of an object captured using the image capturing apparatus under the second condition.

2. The image shading correction method according to claim 1,
wherein the correction step includes:
a calculation step of calculating, based on the first to third image signals obtained in the obtaining step, a fourth image signal of an image captured of the area having a uniform luminance distribution using the image capturing apparatus under the second condition; and
an arithmetic step of correcting shading of an image of an object captured using the image capturing apparatus under the second condition by performing arithmetic processing using the fourth image signal.

3. The image shading correction method according to claim 2,
wherein the calculation step includes a first step of obtaining a difference signal between the first image signal and the second image signal, and a second step of calculating the fourth signal by adding the difference signal to the third image signal, and
the arithmetic step includes a third step of generating, based on the fourth image signal, a function for correcting image shading, and a fourth step of correcting the image by multiplying, by the function, the image of the object captured using the image capturing apparatus under the second condition.

4. The image shading correction method according to claim 3,
wherein each of the image signals includes a vector component in color space of light, and
the difference signal includes a difference vector component in the color space of light.

5. An image capturing apparatus including a shading correction unit that corrects shading of a captured image, the apparatus comprising:
an information holding unit that holds a first image signal of an image captured of an area having a uniform luminance distribution using another image capturing apparatus under a first condition, a second image signal of an image captured of the area having a uniform luminance distribution using the other image capturing apparatus under a second condition, and a third image signal of an image captured of the area having a uniform luminance distribution under the first condition, and
an arithmetic unit that performs arithmetic processing using the first to third image signals held by the information holding unit,
wherein the shading correction unit performs shading correction on an image of an object captured under the second condition, using a result of the arithmetic processing.

6. An image capturing apparatus including a shading correction unit that corrects shading of a captured image, the apparatus comprising:
an information holding unit that holds a difference signal between a first image signal and a second image signal, the first image signal being a signal of an image captured of an area having a uniform luminance distribution using another image capturing apparatus under a first condition, and the second image signal being a signal of an image captured of the area having a uniform luminance distribution using the other image capturing apparatus under a second condition, and holds a third image signal of an image captured of the area having a uniform luminance distribution under the first condition, and
an arithmetic unit for performing arithmetic processing using the difference signal and the third image signal held by the information holding unit,
wherein the shading correction unit performs shading correction on an image of an object captured under the second condition, using a result of the arithmetic processing.
